(19) United States
(12) Patent Application Publication
(10) Pub. No.: US 2011/0175934 A1
(43) Pub. Date: Jul. 21, 2011

(54) FRONT PROJECTOR

(75) Inventors: Elvira Johanna Maria Paulussen, Reppel-Bocholt (BE); Vlatko Milosevski, Eindhoven (NL); Egbert Lenderink, Eindhoven (NL); Joseph Ludovicus Antonius Maria Sormani, Eindhoven (NL); Lingli Wang, Bad Kreuznach (DE)

(73) Assignee: KONINKLIJKE PHILIPS ELECTRONICS N.V., EINDHOVEN (NL)

(21) Appl. No.: 12/674,179

(22) PCT Filed: Aug. 21, 2008
(86) PCT No.: PCT/IB08/53352

§ 371 Date: Feb. 19, 2010

(30) Foreign Application Priority Data
Aug. 28, 2007 (EP) 07115127.8

(51) Int. Cl. G09G 5/10; G03B 21/26

(52) U.S. Cl. 345/690; 353/30; 353/31

(57) ABSTRACT

A front projector (FP) comprises an image generating device (DP) which generates an image in accordance with an input display signal (IDS). A projection lens (PL) projects the image to obtain a projected image (PL) on an projection area (IPA). At least one light source (LS1, LS2; L1, L2, L3) generates at least one ambient light beam (ALB1, ALB2) which is projected via said same projection lens (PL) to obtain an ambient light image (ALI1, ALI2) at least partly flanking said projected image (PI).

### FIELD OF THE INVENTION

The invention relates to a front projector, and to a method of projecting an image.

### BACKGROUND OF THE INVENTION

U.S. Pat. No. 7,071,897 B2 discloses a display system for displaying images of high resolution on a main screen, and augmentation images in augmentation regions located around the main screen. The viewing experience is enhanced by the presence of the augmentation images because of the increase in visual information conveyed to the viewers. The augmentation regions lie outside the foveal field of view of the viewers, so the augmentation images can be of lower resolution than the high resolution images displayed on the main screen. In an embodiment of this prior art, the display system comprises a main projector which projects the high resolution images on the main screen, a left and right panel projector which project the low resolution images on left and right panel screens flanking the main screen and left and right sides, respectively. This embodiment further comprises first and second right side and first and second left side light sources to project light on the side walls of the room, and left and right ceiling light sources to project light on the ceiling of the room.

In such a display system it is quite difficult to setup the system such that especially the main image and the images on the left and right panel are correctly aligned, and are kept in focus. However, such a system is getting very complicated if a zooming function is implemented.

### SUMMARY OF THE INVENTION

It is an object of the invention to provide a display system in which the main image is at least partly flanked by an ambient lighting generated by an ambient light source without requiring difficult alignment procedures when zooming.

A first aspect of the invention provides a front projector as claimed in claim 1. A second aspect of the invention provides a method of projecting as claimed in claim 14. Advantageous embodiments are defined in the dependent claims.

A front projector in accordance with the first aspect of the invention comprises an image generating device, a projection lens and at least one light source. The image generating device generates an image in accordance with an input display signal. This image is identical to the main image of the prior art. The projection lens projects the main image on an image projection area to obtain a projected image. For example, the image projection area may be a projection screen or a suitably prepared wall. The at least one light source generates at least one ambient light beam which is projected via the same projection lens to obtain an ambient light image at least partly flanking said projected image. With partly flanking is meant that the projected ambient light image at least over a particular distance flanks the projected main image. For example, particular distance may be both the left and right sides of the main image. Alternatively, the projected ambient light image may surround the projected main image completely. The ambient light image may directly adjacent to the projected main image in that the borders of both images touch. Alternatively, there may be a free space between the projected main image and the projected ambient light image.

By using a separate ambient light source which is arranged in the front projector in such a manner that the ambient light beam generated by the ambient light source passes through the same projection lens as the main image, the alignment of the ambient light image with respect to the main image can be performed during production of the front projection and does not request a cumbersome alignment procedure (or a very sophisticated design of the separate projectors of the prior art) if the main image is zoomed because both the main image and the ambient light image are zoomed with the same projection lens.

In an embodiment the image generating device comprises a first, second and third display panel which supply differently colored portions of the image. For example, in such a setup, the three display panels are LCD panels which respectively provide the red, green and blue part of the image. Alternatively, more than three different colors and thus associated different display panels may be used to compose the total image. Other primary colors than red, green and blue may be used. The differently colored portions may be supplied time sequentially or time overlapping. In a time sequential approach a single display panel may suffice.

In an embodiment, the at least one light source comprises a first, second and third light source. The front projector further comprises a signal processor and a recombination cube. The signal processor receives the input display signal to supply a first, second and third drive signal to the first, second and third display panel, respectively. The recombination cube has input sides arranged for respectively receiving: (i) at a first input side, the first portion of light from the first display panel and light from the first light source which both have the first color, (ii) at a second input side, the second portion of light from the second display panel and light from the second light source which both have the second color, and (iii) at a third input side, the third portion of light from the third display panel and light from the third light source which both have the third color. The first, second and third light source are arranged with respect to the respective input sides of the recombination cube such that the first, second and third portion of light are not blocked. Or said differently, the first, second and third portion of light emitted by the separate first, second and third light sources, respectively is inputted into the respective input sides of the recombination cube without disturbing the light inputted by the first, second and third display panels.

It has to be noted that the recombination cube as such is well known in the art. For example, for a three color system, such a recombination cube may comprise two semi-transparent color filters arranged under 45 degrees with respect to the associated input planes forming the input sides to combine the three color images generated by the three display panels to a single image at an output side of the recombination cube. This single image is projected by the projection lens on the image projection area.

In an embodiment, the front projector comprises a signal processor and a recombination cube. The signal processor receives the input display signal to supply first, second and third drive signals to the first, second and third display panel, respectively. The recombination cube has input sides arranged to respectively receive the first, second and third portion of light and color filters for directing the received first, second and third portion of light to a common output side to obtain the image light beam which is projected on the image projection area to obtain the main image. The at least one light source is arranged in an area between the projection lens and a plane comprising the common output side but besides the common output side to prevent blocking of the image light beam of the main image. Thus also the light generated by the at least one light source will be projected via the projection lens.

In an embodiment, the image generating device comprises a reflective matrix panel with pixels for selectively reflecting light towards the projection lens in accordance with the input display signal. The at least one light source is arranged to illuminating border pixels of the reflective matrix panel. In this embodiment, the border pixels of the reflective matrix panel are used to selectively reflect the light of the at least one light source to obtain the ambient light at the corresponding border area of the main image to modulate the intensity of the light. If the differently colored images are generated time sequential, or if a multi colored reflective matrix panel is used, only a single display panel is required. For example, the reflective matrix display is a DMD panel. The border pixels may extend over a limited length or over the complete length of one or more border sides of the display panel. The use of the border pixels has the advantage that the light emitted by the at least one light source can easily be varied in intensity, for example to fit the average intensity of the main image.

In an embodiment, a main light source, via a field lens, illuminates the pixels of the reflective matrix panel but not the border pixels, and the at least one light source, which illuminates the border pixels, is arranged adjacent the field lens. Now both the light of the main light source and of the at least one light source seem to originate from the same position and thus are treated in the same manner.

In an embodiment, the image generating device comprises a reflective matrix panel and a separate reflective area. The reflective matrix panel has pixels to selectively reflect light towards the projection lens in accordance with the input display signal. The reflective means, which is illuminated by the at least one light source, are arranged in a plane parallel to the reflective matrix panel at least one of the edges of the reflective matrix panel. Such a separate reflective area has the advantage that it is not required to reserve an amount of display pixels for the ambient lighting thereby decreasing the resolution of the main image.

In an embodiment, the main light source illuminates the pixels of the reflective matrix panel, the reflective means are arranged in a plane of the reflective matrix panel, and the at least one light source is arranged adjacent the field lens. Now, again, both the light of the main light source and of the at least one light source seem to originate from the same position and thus are treated in the same manner. Further, also the reflective matrix panel and the reflective means are arranged in the same field, all the light reflected is handled in the same manner by the projection lens.

In an embodiment, the front projector comprises a signal processor which receives the input display signal to supply drive signals to the display panel to obtain differently colored sub-images of the image sequentially in time. Such a sequential drive enables to use a single display panel only.

In an embodiment, the at least one light source comprises a light emitting diode which is able to produce differently colored light. The front projector comprises a control circuit which controls a color and/or intensity of the ambient light image. The color and/or intensity of the ambient light image may be controlled in many ways. For example, the color and intensity may be varied in accordance with the average color and intensity of the complete image, or of a portion of the image adjacent to the border of the image where the ambient light is added. For example, if the ambient light is added to the right and left border of the main image, the ambient light left depends on the intensity and color of the main image in the left half or quarter of the image adjacent to the left border of the main image, and the ambient light right depends on the intensity and color of the main image in the right half or quarter of the image adjacent to the right border of the main image. A same approach may be implemented for the top and bottom borders of the main image. Any of the top, bottom, left or right side ambient light may be further divided in sub-portions such that a plurality of zones of ambient light occur. Each zone may be illuminated by its associated light emitter or group of light emitters.

In an embodiment, the at least one light source comprises at least three differently colored light emitting diodes. The front projector comprises a control circuit which controls a color and/or intensity of the ambient light beam which is emitted by a combination of the at least three differently colored light emitting diodes. By using the three colored light emitting diodes, several colors can be made by controlling an amount of current through the diodes. In an embodiment, the colors of the diodes are selected such that it is possible to make white light. It has to be noted that with color of the light emitting diode is meant the color of the light emitted by the light emitting diode.

In an embodiment, shaping optics are arranged between the at least one light source and the projection lens for shaping the at least one ambient light beam to obtain a larger projected ambient light area. These shaping optics have the function to collect the light emitted by the light emitter(s) and to direct the collected light towards the desired area besides the main image. For example, the light may be collected with a collimator. The shaping optics may comprise so called free shape optics and/or diffractive optics. In an embodiment, the free shape optics and especially the diffractive optics may be combined with a mask arranged in front of the ambient light sources to obtain a sharply bordered projection of the ambient light.

These and other aspects of the invention are apparent from and will be elucidated with reference to the embodiments described hereinafter.

### BRIEF DESCRIPTION OF THE DRAWINGS

In the drawings:

FIG. 1 schematically shows an embodiment of a front projection system,

FIG. 2 schematically shows an embodiment of a front projector,

FIG. 3 schematically shows another embodiment of a front projector,

FIG. 4 schematically shows a top view indicating the position of the light sources with respect to the recombination cube of the embodiment of the front projector shown in FIG. 3,

FIG. 5 schematically shows an embodiment of a front projector, and

FIG. 6 schematically shows another embodiment of a front projector.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

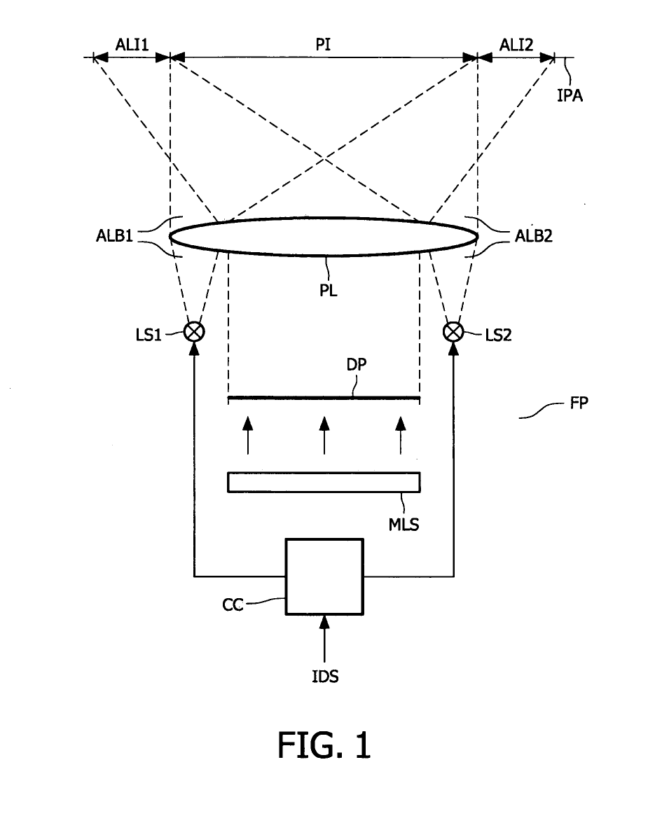

FIG. 1 schematically shows an embodiment of a front projection system. The front projection system comprises a front projector FP which projects a projected image PI on a projection area IPA which, for example is a projection screen sufficiently large to show the projected image flanked by an ambient light image ALI1, ALI2.

The front projector FP comprises a display panel DP which is illuminated by a main light source MLS. The display panel DP may be a matrix display panel such as for example a LCD panel. In the embodiment shown in FIG. 1, the display panel DP is a light transmissive panel and the light from the main light source which passes the display panel DP is projected by the projection lens PL on the projection area IPA. Alternatively, the display panel DP may be a reflective panel, such as for example a DMD panel. Now, the position of the main light source and the display panel DP should be such that the light reflected by the display panel DP is projected by the projection lens PL on the projection area IPA. The pixels of the display panel DP are selectively driven (not shown) in a well known manner in accordance with the input display signal IDS.

The front projector FP further comprise the light sources LS1 and LS2 which are positioned in an area in-between the projection lens PL and a plane through the display panel DP but besides the light beam from the display panel DP towards the projection lens. The ambient light generated by these light sources LS1 and LS2 is projected by the projection lens PL on the projection area at the left and right hand side of the projected image PI to obtain the ambient light images ALI1 and ALI2, respectively. The references ALB1 and ALB2 indicate the ambient light beams which are projected via the projection lens PL.

In the example shown, the ambient light images ALI1 and ALI2 are immediately adjacent the projected image PI at the left and right hand side. Alternatively, the ambient light images may be generated on top of and/or at the bottom of the projected image. Alternatively, the ambient light image may completely surround the projected image PI. The ambient light images ALI1 and ALI2, and/or the top/bottom ambient light images must not be projected immediately adjacent the projected image PI. However, a too large distance between the projected image PI and the ambient light images has several drawbacks. The ambient lighting effect which in fact extends the area of the projected area PI becomes less, and either the width of the ambient light image becomes small or the projection lens PL has to become relatively large with respect to its dimension required to project the main image generated by the display panel DP.

Optionally, the ambient light sources LS1 and LS2 may be controlled by a controller CC in response to the input display signal IDS. For example, the current through the light sources LS1, LS2 may be controlled such that the color and/or intensity of the light emitted by the light sources LS1, LS2 varies in accordance with a property of the main image. For example, the color and intensity of the light source LS1, LS2 is controlled to match an average color and intensity of a portion of the main image adjacent the border of the main image nearest to the light source LS1, LS2.

It has to be noted that the light sources LS1 and LS2 are shown very schematically only. These light sources may comprise optical elements to gather and concentrate or shape the light. The light emitting elements of the light sources may be any type of filament, halogen, low or high pressure lamps or semiconductor light emitters such as for example LED's. A single elongated or meandering lamp may be used. A single lamp having any shape, a single LED may be used together with optics to obtain an elongated ambient light image on the projection area IPA. The single lamp or LED may be controlled to vary its intensity and color. Instead of a single lamp or LED, a group of lamps and LED's emitting different colors may be used. The plurality of lamps and LED's may be arranged in an elongated array to obtain an elongated ambient light image. Optics may be used to shape the light of the lamps or LED's to obtain a desired width of the projected ambient light image ALI1, ALI2. Combinations of lamps and LED's may be used.

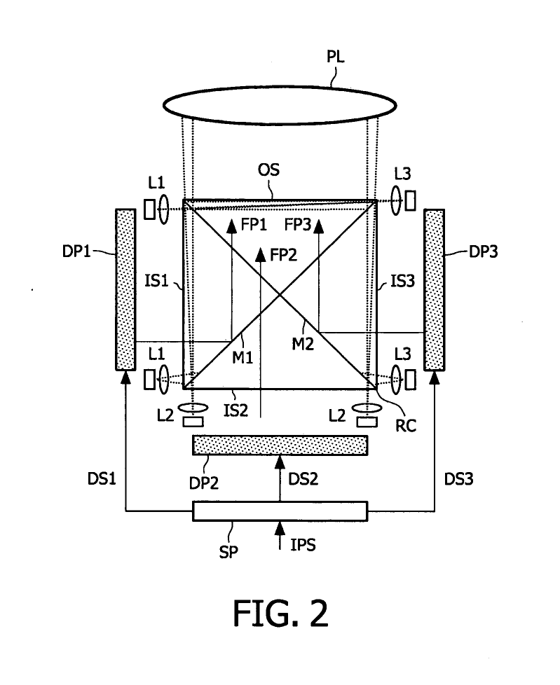

FIG. 2 schematically shows an embodiment of a front projector. The front projector FP comprises three display panels DP1, DP2 and DP3, a recombination cube RC (in literature also referred to as X-prism), ambient light sources L1, L2 and L3, a projection lens PL, and a signal processor SP.

By way of example, this embodiment will be explained by assuming that the display panel DP1 provides the red part FP1 of the image, the display panel DP2 the green part FP2 and the display panel DP3 the blue part FP3. However, any other set of primary colors instead of red, green and blue may be used as well.

The red image part FP1 generated by the display panel DP1 enters the recombination cube RC at its input side IS1 and is reflected by the semi transparent color reflector M1 which reflects red light and transmits green light. Thus, the red light originating from the display panel DP1 is reflected by the semi transparent color reflector M1 towards the output side OS of the recombination cube RC. The blue image part FP3 generated by the display panel DP3 enters the recombination cube RC at its input side IS3 and is reflected by the semi transparent color reflector M2 which reflects blue light and transmits green light. Thus, the blue light originating from the display panel DP3 is reflected by the semi transparent color reflector M3 towards the output side OS of the recombination cube RC. The green light originating from the display panel DP2 passes through both the semi transparent color reflectors M1 and M2 and also leaves the recombination cube RC at the output side OS. The total image is projected by the projection lens PL on the projection area IPA.

The light sources L1 emit light into the input side IS1 in an area corresponding to the area of the projection area IPA where the ambient light image should be projected. The light sources L1 are positioned such that they do not block the light originating from the display panel DP1. It has to be noted that only the light of the light sources L1 which is reflected by the semi transparent color reflector M1 reaches the output side OS. Consequently, the light sources L1 should at least emit red light. The efficiency of the system is optimal if the light sources L1 emit only red light which will be reflected to the output side OS. For example, the light sources L1 are red LED's. A similar reasoning holds for the position of and light emitted by the light sources L2 and L3 towards the input sides IS2 and IS3, respectively. An optimal efficiency is obtained if the light sources L2 emit green light, and the light sources L3 emit blue light. By way of example only, the light sources L1, L2 and L3 are shown to be composed out of a light emitter (the rectangles) and a lens.

The signal processor SP supplies drive signals DS1, DS2 and DS3 to the display panels DP1, DP2 and DP3, respectively to control the transmission of their pixels. Because three display panels DP1, DP2 and DP3 are used, the red, green and blue pixels may be generated coincidentally. If a single display panel is present the red, green and blue sub-images may be generated time sequentially, for example by sequentially changing the color of the light impinging on the single display panel.

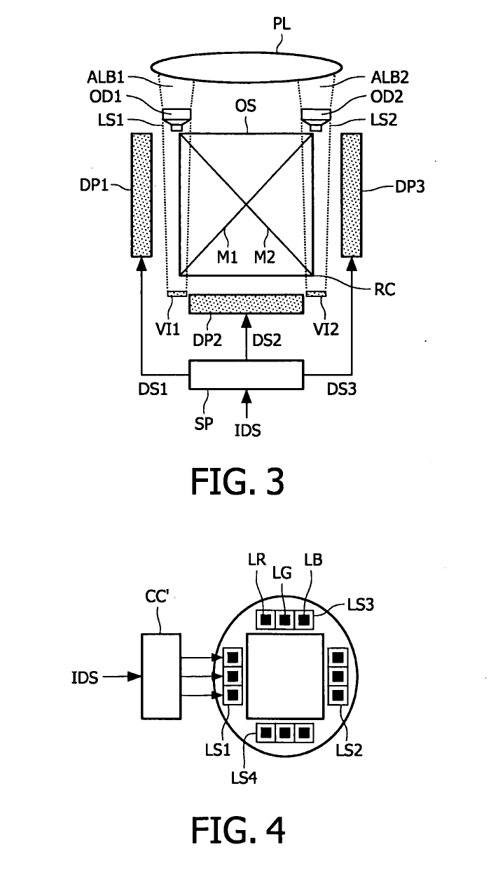

FIG. 3 schematically shows another embodiment of a front projector. The front projector FP comprises three display panels DP1, DP2 and DP3, a recombination cube RC, ambient light sources LS1 and LS2, a projection lens PL, and a signal processor SP. Again, by way of example, this embodiment will be explained by assuming that the display panel DP1 provides the red part FP1 of the image, the display panel DP2 the green part FP2 and the display panel DP3 the blue part FP3. However, any other set of primary colors instead of red, green and blue may be used as well. The part of the front projector FP which comprises the display panels DP1, DP2 and DP3, the recombination cube RC and the signal processor SP is identical to that of FIG. 2 and is therefore not discussed again.

Now, the light sources LS1 and LS2 are arranged in an area in-between the projection lens and a plane comprising the output side of the recombination cube RC. Further, the light sources LS1 an LS2 are positioned such that they do not block the light leaving the output side OS. The light beams ALB1 and ALB2 of the light sources LS1 and LS2, respectively, are projected by the projection lens PL.

The light sources LS1 and LS2 may comprise optics OD1, OD2 acting as a positive lens. For example, the optics OD1, OD2 may comprise a cylinder lens or diffractive optics. The positive lens may be designed such that the respective virtual images VI1 and VI2 of the light sources LS1 and LS2 have substantially the same optical distance to the projection lens PL as the display panels DP1, DP2 and DP3.

The light sources LS1 and LS2 may generate the ambient light for the left and right sides of the projected main image PI. Alternatively, the light sources LS1 and LS2 may generate the ambient light for the top and bottom sided of the projected main image PI. The projector may comprise further light sources (not shown) such that the ambient light is produced along the left side, the right side, the top and bottom of the projected main image PI. In an embodiment, each one of the light sources LS1, LS2 is able to vary the intensity and color of the light generated. Further, in an advantageous embodiment, the light sources LS1 and LS2 are able to generate all colors the projected main image PI may have such that the ambient light generated can be used as a natural extension of the main image PI.

FIG. 4 schematically shows a top view indicating the position of the light sources with respect to the recombination cube of the embodiment of the front projector shown in FIG. 3. In this embodiment, four light sources LS1 to LS4 are present, each one at one edge of the output side OS such that the projected main image PI is surrounded by ambient light. As schematically shown, each one of the light sources LS1 to LS4 comprises three LED's LR, LG and LB which emit light having primary colors. In a preferred embodiment, the primary colors of the three LED's are identical to the primary colors used to generate the sub-images or image parts FP1, FP2 and FP3. Alternatively, more than one group of three LED's may be positioned along an edge of the output side OS.

Although in FIG. 4 only a single control circuit CC′ is shown which drives the three LED's LR, LG, LB of the light source LS1, the same or other control circuits may be present to drive the LED's of the other light sources LS2 to LS4. If the variation of the ambient light at different borders of the projected main image PI should differ, for example based on the actual image portion displayed near the respective different borders, all the LED's of all the light sources LS1 to LS4 should be separately driveable.

In the setup shown in FIG. 2, the virtual or real image of the ambient light sources L1, L2, L3 lies close to the ambient light sources which make the set-up more complex and tolerance sensitive than the setup shown in FIG. 3 wherein the virtual images VI1 and VI2 lie relatively far away from the light sources LS1 and LS2. However, the real image may be generated by optics having a very short focal distance.

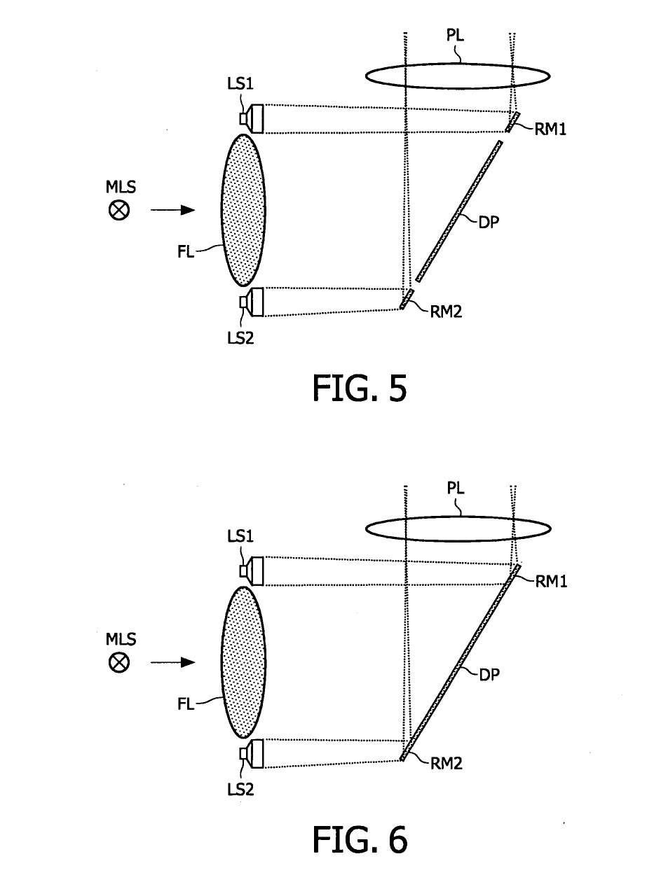

FIG. 5 schematically shows an embodiment of a front projector. The front projector FP comprises a main light source MLS which illuminates a reflective display panel DP via a field lens FL. The reflective display panel may be a matrix display panel such as for example a DLP or DMD panel which selectively per pixel can reflect the impinging light towards the projection area IPA via the projection lens PL. Front projectors using reflective matrix display panels are well known and are therefore not discussed in detail.

The front projector FP further comprises ambient light sources LS1 and LS2 which are arranged adjacent the field lens and which emit ambient light towards the reflective parts RM1 and RM2 which are arranged in the same plane as the reflective display panel DP and adjacent an edge of the display panel DP. In the embodiment shown, only two light sources LS1 and LS2 and two reflective parts RM1 and RM2 along the left and right side of the reflective display panel DP are shown to obtain ambient light images at the right and left side of the projected main image. Alternatively, these two light sources LS1 and LS2 and the associated reflective parts RM1 and RM2 may be positioned along the top and bottom of the reflective display panel DP. In another embodiment, four light sources may be present together with one or four associated reflective parts to obtain an ambient light image surrounding the projected main image PI.

Again, the light sources LS1 and LS2 may comprise optical components acting as a positive lens.

In a simple embodiment, the reflective parts RM1 and RM2 are static in that it is not possible to modulate the amount of light reflected. For example, the reflective parts RM1 and RM2 are fixed positioned mirrors. If in this embodiment a modulation of the color and/or intensity of the ambient light is desired, the light source LS1, LS2 has to be able to vary its color and/or intensity. For example, the light source LS1, LS2 may comprise three or more LED's which emit three or more different primary colors. A controller controls the currents through the differently colored LED's to obtain the desired color and intensity of the ambient light.

FIG. 6 schematically shows another embodiment of a front projector. The only difference between this embodiment and the embodiment shown in FIG. 5 is that instead of the separate reflective parts RM1 and RM2 now the border areas of the reflective display panel DP are used to reflect the ambient light towards the projection lens PL. This has the advantage that the light source LS1, LS2 itself need not be able to vary its intensity because the intensity of the ambient light projected through the projection lens PL can be varied by controlling the pixels of the border area of the reflective display panel DP. Of course, the projected ambient light may be varied by controlling both the reflectivity of the reflective display panel DP and the light source LS1, LS2. For example, if the light source LS1, LS2 is a lamp which generates white light of which the intensity is difficult to be controlled, the border pixels of the reflective display panel may be controlled to obtain the desired intensity of the ambient light. It is instead or additionally possible to also control the color of the ambient light by varying the color emitted by the ambient light source and/or using a switchable or movable color filter (for example a color wheel) to be able to sequentially in time modulate the different colors of the ambient light source. Such a color filter is not required if the pixels of the border area are only used to vary the intensity of the light from the light source LS1, LS2.

It should be noted that the above-mentioned embodiments illustrate rather than limit the invention, and that those skilled in the art will be able to design many alternative embodiments without departing from the scope of the appended claims. Although the embodiments have explained in systems based on the three primary colors red, green and blue, different primary colors, and/or more than three primaries may be used. Instead of LCD, DMD, DLP display panels DP any other display panels which selectively transmit or reflect light can be used, such as for example a LCOS display panel.

In all embodiments, the ambient light source may comprise a group of differently colored light emitters, such as for example LED's, such that the color and/or intensity of the ambient light generated can be controlled. For example, the light emitters may emit red, blue and green light, respectively.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A front projector, comprising
an image generating device for generating an image in accordance with an input display signal,
a main light source for illuminating the image generating device,
a projection lens for projecting the image to obtain a projected image on an projection area, and
at least one auxiliary light source for generating at least one ambient light beam being projected via said projection lens to obtain an ambient light image at least partly flanking said projected image.

2. A front projector as claimed in claim 1, wherein the image generating device (DP) comprises
a first display panel for supplying a first portion of the image representing a first primary color of the image,
a second display panel for supplying a second portion of the image representing a second primary color of the image, and
a third display panel for supplying a third portion of the image representing a third primary color of the image, wherein the first, second and third portions together form the image.

3. A front projector as claimed in claim 2, wherein the at least one light source comprises a first light source, a second light source and a third light source, and wherein the front projector comprises
a signal processor for receiving the input display signal for supplying a first drive signal to the first display panel, a second drive signal to the second display panel and a third drive signal to the third display panel,
a recombination cube having (i) a first input side for receiving the first portion of light (FP1) and light comprising the first color and being emitted by the first light source, (ii) a second input side for receiving the second portion of the light and light comprising the second color and being emitted by the second light source, and (iii) a third input side for receiving the third portion of light and light comprising the third color and being emitted by the third light source, wherein the first light source, the second light source and the third light source are arranged with respect to the respective input sides of the recombination cube such that the first, second and third portion of light are not blocked.

4. A front projector as claimed in claim 2, further comprising
a signal processor for receiving the input display signal for supplying first drive signals, second drive signals and third drive signals to the first display panel, the second display panel and the third display panel, respectively, and
a recombination cube having input sides arranged for respectively receiving the first portion of light, the second portion of light and the third portion of light and optical means for directing the received first, second and third portion of light to a common output side of the recombination cube to obtain the projected image, wherein the at least one auxiliary light source is arranged in an area between the projection lens and a plane comprising the common output side but besides the common output side to prevent blocking of the image light beam.

5. A front projector as claimed in claim 1, wherein the image generating device comprises a reflective matrix panel having pixels for selectively reflecting light towards the projection lens in accordance with the input display signal, and wherein the at least one light source is arranged for illuminating border pixels of the reflective matrix panel.

6. A front projector as claimed in claim 5, wherein a main light source is arranged for illuminating via a field lens the pixels of the reflective matrix panel (DP) but not the border pixels, and wherein the at least one light source is arranged adjacent the field lens.

7. A front projector as claimed in claim 1, wherein the image generating device comprises
a reflective matrix panel having pixels for selectively reflecting light towards the projection lens in accordance with the input display signal, and
a reflective means arranged in a plane parallel to the reflective matrix panel (DP) at least one of the edges of the reflective matrix panel, and wherein the at least one light source is arranged for illuminating the reflective means.

8. A front projector as claimed in claim 7, wherein the main light source is arranged for illuminating the pixels of the reflective matrix panel, wherein the reflective means are arranged in a plane of the reflective matrix panel, and wherein the at least one light source is arranged adjacent the field lens.

9. A front projector as claimed in claim 5, wherein the front projector comprises a signal processor for receiving the input display signal (IDS) for supplying drive signals to the display panel to obtain differently colored sub-images of the image sequential in time.

10. A front projector as claimed in claim 1, wherein the at least one auxiliary light source comprises a light emitting diode configured to produce differently colored light, and wherein the front projector comprises a control circuit for controlling a color and/or intensity of the ambient light image.

11. A front projector as claimed in claim 1, wherein the at least one auxiliary light source comprises at least three differently colored light emitting diodes, and wherein the front projector comprises a control circuit for controlling a color and/or intensity of the ambient light beam being emitted by a combination of the at least three differently colored light emitting diodes.

12. A front projector as claimed in claim 10, wherein the control circuit is constructed for controlling the color of the ambient light beam in accordance with a property of the input display signal.

13. A front projector as claimed in claim 1, further comprising shaping optics arranged between the at least one light source and the projection lens (PL) for collecting the light of the at least one light source and for directing the at least one ambient light beam to obtain an ambient light image at least partly flanking said projected image.

14. (canceled)
